(19) United States
(12) Patent Application Publication
(10) Pub. No.: US 2005/0114484 A1
(43) Pub. Date: May 26, 2005

(54) Richard and Preston super network, "The Super Net"

(76) Inventors: Richard Phillip Wilson, Greensboro, NC (US); Preston Harold Wilson, Greensboro, NC (US)

Correspondence Address: Richard Wilson, 111 N. Benbow Rd., Greensboro, NC, 27401, US

(21) Appl. No.: 10/614,003

(22) Filed: Jul. 8, 2003

Related U.S. Application Data
(60) Provisional application No. 60/394,279, filed on Jul. 9, 2002.

(51) Int. Cl. G06F 15/173

(52) U.S. Cl. 709/223; 709/218

(57) ABSTRACT

We have invented extensions to the current Domain Name System which include top level domains that create more available domain names. Some of the newly introduced top level domains provide information on a web sites location of operation. This will enable search engines to categorize search results based on location. Also the domain name systems we introduce, provide a long term method of expanding the current domain name system. They also offer domain names which include words internet users are familiar with. Some of the new top level domains address growing internet related areas in which domain name usage will be pertinent. Areas such as communications and internet capable devices will benefit from the top level domains created specifically for them. Another area addressed by the new top level domains is countries with large internet usage. Countries like Japan United States and China can use multiple top level domains created specifically for them because of their large number of internet users and high tech businesses. The need for personal web sites is also increasing. Internet profiles are means for people to allow others to view information about them. A new extension for personal websites will allow more people to have a web address to post information about them. The domain name systems and top level domains we have invented will coexist with the current domain name system.

### CORRESPONDING PROVISIONAL PATENT APPLICATION

Application No. 60/394,279

### FEDERALLY SPONSORED RESEARCH

Not Applicable

### SEQUENCE LISTING OR PROGRAM

Not Applicable

### BACKGROUND

1. Field of Invention

This invention relates to the creation and use of domain names on the internet

2. Description Of Prior Art

Current Domain System

Internet use is growing quickly. FTP, e-mail, the World Wide Web: businesses are fast finding these tools indispensable in today's lightening-paced world of marketing and technology. Although the payoff may sometimes seem uncertain, more and more companies are using the Internet and developing “websites” to sell and advertise their goods and services. Developing a website requires an address, or IP, for customers and visitors to locate the site. Domain names are registered on a first come, first served basis.

The current domain name system offers domain names based on the top level domains (tlds) assigned by the Internet Corporation for Assigned Names and Numbers (ICANN). Some of these top levels domains were created for use in certain areas (such as nonprofit organizations) and others were created for use by a particular country. For example the .com tld was created for websites with information pertaining to business and the .net top level domain was created for websites pertaining to networking. Another example is the .us top level domain created for use by the United States of America.

A company's domain name is the front line of their electronic presence. Whether their image is stayed and secure, or new and cutting-edge, what a company chooses in a name will reflect greatly on the public's perception and reaction to their site. Start-up companies often choose abstract names to describe what they do and then turn that name into a logo that is marketable. In contrast, many companies that are already established in the “brick-and-mortar” world prefer to build on their already-visible and established name. Domain names made up of the traditional trade names of such a company have the added benefit of giving customers more ease of recognition, and this is especially important in the virtual village of some 300 million users that comprises the World Wide Web.

### BACKGROUND OF INVENTION

Our invention addresses the current domain name system by creating an extendible and more suitable domain name system. The domain systems we have created are not designed to replace to current domain system. Our domain systems are designed to exist along with the current domain system by adding more domain name options. The current domain name system uses multiple domains names. Some of the top level domains such as .com, .net, and .org are for the general public usage where as others have restricted usage such as .gov and .edu. Because of the tremendous amount of individuals and businesses that desire to acquire a domain name, we have introduced a way to offer more domain names. The domains systems we have invented coexist together. They make up one big domain system. We want to make it clear that the domain systems we have invented are not designed to exist along. They are created with the idea that they will exist together along with the current domain system. The domain systems we have invented will be implemented by methods that will make them independent of ICANN, the committee that oversees the current domain system. The domain systems we introduce are based on the creation of new types of domains. Next we list some disadvantages of the current domain system and we list the advantages of our extensions to the current domain name system.

Limitations of Current Domain Name System

I. Limited number of top level domains available for consumer use. With the current top level domains users, who want a domain name in order to create a web site, are limited.

II. Certain vital internet areas need their own top level domain or more than one top level domain specifically for that area.

III. Most of the top level domains which are open to the public for registration are not based on location. Current domain names offer no information in the domain name on where the business, organization or individual who owns the domain resides.

IV. Top level domains are assigned to each country by the same rules and regulations. Being that each country each has different top level domains needs based on the amount of internet users in the country and the amount of businesses in the country which desire an internet presence.

Advantages of the Domain Name Systems and Top Level Domains We Have Invented

I. We offer a solution in which a business, individual or organization can choose a domain based not only on a particular name they want but also on their location.

II. We offer solution that offers top level domains, which define areas in which there is a large need for domain names. Some of the defined areas are internet capable devices, email and personal web pages.

III. We offer a solution that is expandable based the number individuals who desire a domain name. This is important because it does not flood the domain name system with tld's but introduces them gradually.

IV. Our invention does not conflict with currently used top level domains. Also our invention will exist alongside the current domain system.

V. In this invention we also have invented the concept of a search engine in which websites can be listed corresponding to either users requested search area or where the user is located. For instance if the users wanted to search for websites of businesses in the state of North Carolina, which is in the United States they could choose North Carolina when they search. The search results would include domains which have information pointing to North Carolina.

### DETAILED DESCRIPTION OF INVENTION

We have invented a new domain name system which includes the use of more appropriate domains based on the tremendous growth of the internet. Our new system is based on the creation of new top level domains which do the following:

I. This invention creates the concept of creating new top level domains based on location within a particular country. We feel that whereas there exist one top level domain for each country there needs to be multiple top level domains created for each country which relate to specific areas within the country.

II. This invention creates top level domains created based on location in combination with traditional top level domains (com, biz, net, org, us). We introduce top level domains which include information in the domains which relates to the area of the domains place of operation. When we say area of operation this serves two purposes. It can mean the base location of the business, person, or organization in which the domain name points to. Active domain names refer to websites which usually represent some type of business, person or organization. The other purpose may be to represent the area in which the website, the domain name represents, serves. Say someone had a business located in the area code 336, which is in the state of North Carolina, which is in the United States of America. Within the domain the area code 336 could be including which would notify people about the domains base location of operation. The domain could also use the abbreviation nc which notify users of the state in which the domains base operation is located. The domain could also be setup to include information about the domains span of operation. Say the domain names operations catered towards individuals across the state of Texas. Either Texas or its abbreviation tx could be included in the top level of the domain.

III. Special Consideration Areas

This invention introduces the concept of creating top level domains for use in the device industry and communications industry. The device industry includes any device capable of accessing the internet. We also introduce the concept of creating top level domains without them being approved by ICANN for the purposes of personal website and email usage. Some of the new top level domains we have created address growing internet related areas in which domain name usage will be pertinent. Areas such as communications and internet capable devices will benefit from the top level domains we have created specifically for them. Another area addressed by the new top level domains is countries with large internet usage and economy. Countries like Japan and the United States need multiple top level domains created specifically for them because of their large number of internet users and their high level of technology. The need for personal web sites is also increasing. Internet profiles are means of people allowing others to view information about them. A new extension for personal websites will allow more people to have a web address to post information about them. We have also created top level domains which will be used mainly for email purposes.

IV. Reverse Domain System

The new domain names created in this new system are created by reversing the way the current domain names are created. An example of a domain created in this system is com.business. In the current domain system com is usually the top level part of the domain but in this example it is on the secondary level of the domain and a new top level domain business is created. Other example domains created using this new system are com.store, biz.mall, net.houses. This new system is not designed to replace the current domain system. It is designed to extend it by creating more available domains. In order top preserve the use of commonly used top domains, in this new domain system only top level domains currently approved by ICANN or top level domains introduced in this invention will be used on the secondary level of domains. Using top level domains approved by ICANN also creates domains with words internet users are already familiar with. They have to only adjust to the format of the domain name. Also included in the reverse domain system are the formats domain.w, domain.ww, and domain.www.

V. Higher Level Domains System

Higher level domains are domains that use more than two levels. We will use the word base to describe the top and secondary level of a domain. For example in the domain one.two.com, two.com would be the base domain. We have invented the concept of having multiple users use the same base domain with a different third or higher level domain. For instance business.com could be used as top.business.com and go.business.com. Each of these three domains could have different owners. This can be done by authoritative nameservers for the base domain pointing request for higher level domains to the appropriate address or nameserver which knows the i.p address information for the domain. In this way we would need permission from the base domain owner in order to offer corresponding higher levels of the base. Another way to offer high level domain is by controllers of the top level domain forwarding request for third and higher level domains to nameservers delegated responsible for them. We are including this method as part of are invention also. In the current domain system nameservers delegated authoritative for base domains are assumed authoritative for third and higher level domains. In order for request for the higher level domains to be forwarded to their own authoritative nameserver without going through the base domains authoritative nameserver, higher level domains must be assigned authoritative nameservers at the root name server level. Root name servers are the name servers which currently hold the authoritative name server information for base level domains. By the processes we have invented we could offer high levels of multiple base domains to multiple users by either getting permission from the base domain owner or going directly from root name servers to nameservers listed as authoritative for the higher level domains (third, fourth, etc. . . . ). We also include a specific domain system which falls under this higher level domain system. This system creates higher level domains based on location and use of top level domains registered by multiple persons. Examples of domains created under this system are shop.us.com, help.us.com, shop.jp.com, and go.jp.com. These domains represent the United States and Japan.

VI. Process of Selecting Top Level Domain Based on Location of Operation

The process we are introducing will allow people to select a top level domain based on the base location of the operation in which the domain name represents or the span of area covered by the operation represented by the domain. For example, say some one operates a hair shop based in the area code of 704, which is in the state of North Carolina, which is in the United States of America. The hair shop operator would be given domain choices which include a second level domain relating to hair shop. The top level of the domain would include 704 and nc by themselves or in combination with info, biz, com, net, any other the top level domain approved by ICANN (including country codes) or any top level domain introduced in this invention. This information could either be included in the top level of the domain or in the second, third, . . . level of the domain. An example of some domain choices would be tophairshop.ncbiz, hairshop.704com hairshop.704nc or hairshop.ncus. Some of the domain systems we have invented will include location representation in higher levels of domains. For example the domain name 01.336.phill.wilson.comp.dev includes location representation in the fifth and six level of the domain. This type of domain format will be explained in detailed later on in this document.

VII. Uniformity Consideration

In the domain name systems we are introducing, many of the top level domains include words such as net and com which are being used in the current domain system. This creates a system in which internet users are comfortable with.

VIII. Special Consideration to Top Level Domains Currently Assigned by ICANN

We have made a special effort not to introduce any domains that will interfere with the top level domains regulated by The Internet Corporation for Assigned Names and Numbers (ICANN). ICANN is the non-profit corporation that was formed to assign top level domains managed by root server systems. Our invention will not depend on root server usage. When we refer to root server systems we are talking about the main nameservers that request for top level domains approved by ICANN are sent to. An example are the nameservers operated by Network Solutions which process request for the top level domains org, net and .com. The domain systems we introduce in this invention are not designed to replace the current domain system but to exist along with it. We will not use any top level domains which have been assigned by ICANN at the time we created this patent.

IX. Smart Search Engines

We have created the invention in which search engines where a person can input information about the location of the websites which they would like to view in the search results. The user could also input their location and receive search results based on that location. Location of websites refers to the base location of the operation (business, organization, etc.) that the website represents or the span of area covered by the operation represented by the website. This method will allow search engines to take advantage of the new top level domains we have invented that include location information. In the method we are introducing search engines would allow users to select the particular area they would like to be included in the search results. For example, if someone wanted to search in the area represented by the area code 336, which is in North Carolina, which is a state in the United States. The user could choose the topic of their search, then they could select the country, then state, then area code of interest. These values could be set to default values by the user, the browser, or search engine. Users may also search based on their location. Users could input their location information such as area code, state and country. Then the user could input how far the span of area they would like to search in relationship to their location. The user could input the radius distance area or they could specify local search which would only search websites located within the area code. “State search” would only search websites located within the state and a “country search” which would only search websites located within the country. If the user is searching the web based on the location of websites he or she would have the option to select no particular country which would allow them to search the whole internet with no regards to websites location. To search websites within a particular country the user could select the country then select no particular state or area code. To search a whole state user could just choose country and state and select no particular area code. Included in this invention are different methods for search engines to get the information on the location of the operation (business, organization, etc.,) in which the website represents by either or a combination of these methods:
1) In the top level of the domain (Example the domain topcars.nc336 may represent a website located in North Carolina which is a state in the United States)
2) From a whois database. Whois databases contain information about the location of the person, business or organization that registered the domain, and the location of the Administrative Contact, Technical Contact and Billing Contact for the domain.
3) When someone registers with search engines they could input the location of the website they are registering.
4) In a higher level of the domain (third level or higher). For example in the domain name one.two.three.com, one and two are higher level parts of the domain. Two is on the third level and one is on the fourth level.
5) In the secondary level of a domain. Secondary level of a domain name is the part before the top level. For example in the domain name business.com, business is the secondary level of the domain name.

X. Domain Name System Which Uses Different Symbols in Place of the Periods (.) in Domain Names.

In the current domain name system period symbols are used to separate different levels of domains. We have invented the idea of using other symbols to separate different levels within a domain name. For example the current domain system would use a domain like one.two.three.com. In our invention the domain one*two*three*com may be used. This domain has four levels. Another example of a domain which may be used in this invention is go*to.the/store. This domain has four levels separated by the symbols *,., and /. This part of the invention includes the use of any symbol or symbols other than a period (.) to separate different levels of domain names.hhh

XI. Restricted Access Domain Name Server

In addition to inventing multiple top level domains we have also invented the concept of a domain name system server which handles request for the top level domains and uses an authorization scheme. ISP's and other companies who want to access i.p address information for the top level domains would have to be given access privileges to the authoritative nameservers which hold that information.

XII. Top Level Domains in Multiple Languages

We would also like to include the conversion of all the top level domains we have invented into other languages. In acquiring top level domains, we have invented, users will be able to choose their language of choice. We want to include in our invention the translation and usage of the top level domains, we have introduced, into any other language. The main languages we will use for the domains along with English will be French, Spanish, Chinese, Japanese, and German (Deutsche).

### How to Implement Invention

There are different ways in which we can offer the top level domains we have invented. Here we list possible methods of implementation:

I. Go to Internet Service Providers and have them set their dns servers up to point the request for the tld's we handle to our nameservers where we then point them to the appropriate internet protocol address. This will allow the users of that Internet Service Provider to complete request for the new top level domains. By this method the top level domains we invent will not depend on the approval of ICANN. Also the top level domains we introduce will not depend on the use of the root name servers, which handle request for all top level domains approved by ICANN.

II. Go through the operating system. Operating systems such as Windows 98 have a place in the TCP/IP properties under the control panel in which one choose a list of name servers to handle browser request for domain names. Under the DNS tab there is a text box titled DNS Service Search Order. In this box one can input the nameserver they would like to use to resolve domain names. We would either instruct internet users interested in viewing the new top level domains to input our nameservers in this text box, or have the developer of the operating system input our nameservers into the box upon creation of the operation system or as un update to the operating system. For example Microsoft could list our nameservers in the operating systems they develop search list. We also could use software that includes our nameservers in the DNS Service Search Order. With the use of this method there would be no need for us to have the top level domains we invent approved by ICANN.

III. The idealistic way but through regulations the most difficult way is to have request for the top level domains, we introduce, forwarded to nameservers, we control, by root name servers operated and controlled by companies assigned root server rights by internet regulation bodies such ICANN. Network Solutions is one of the companies that has been given rights to control and regulate root name servers for some of the top level domains (.net, .com and .org) assigned by ICANN. This method would be difficult because Network Solutions and other companies that operate root servers only provide domain name services for top level domains approved by ICANN. In short, if we used this method we would have to get the top level domains we have invented approved by ICANN.

IV. Higher Level Domain System

There are multiple ways for multiple base domains with different owners to be used by multiple user's through higher level domains. The following are methods in which we are considering.

1. Create authoritative name servers for higher level domains, which root name servers use in forwarding request for the domain to the appropriate name server.

2. Have the authoritative name server for the base domain point request for higher level domains to the appropriate I.P address. This could be done by whoever controls the authoritative name server for the base domain. For example, for someone to use one.business.com the authoritative nameserver for business.com would point request for one.business.com to the appropriate internet protocol address or nameserver which knows the appropriate internet protocol address for one.business.com. The internet protocol address used for one.business.com may be hosted under a different web hosting service and or name server system then business.com.

V. Search Engines could implement website location based searches by including the method described in part IX of this invention description in the process they use to allow people to search the internet.

### New Top Level Domains Explanations

New Country Codes Top Level Domains

a) The .eu, .eur., .euc, .epc, .eup, euro top level domains will represent the European Community. The European Community will has a need for top level domains to cater toward their large number of internet users. Because .eu is currently being used by the European Community we will not use it by itself but in combination with other words in order not to create in conflicts.

b) The .usa top level domain will represent the United States of America. The United States has a need for top level domains to cater toward their large number of internet users

c). The ja, jap, jpn, jpa, japa and japan top level domains will be used to represent Japan. Japan has a growing need for multiple top level domains to cater toward their large number of internet users and their strong economy. The .jp domain will only be used in combination with other words to make up top levels domains because it has been assigned by ICANN.

d) The new top level domains chi, chn, chin, chna and china will be used to represent China. China has a growing need for multiple top level domains to cater toward their large number of internet users

e) The following top level domains have been chosen because of the large economies of the countries they represent. We feel that countries with large economies will have the greatest need for more domains.
ger, grm, and gem will represent Germany.
ind, indi, and india will represent India
unk, untk will represent the United Kingdom.
bra, brz will represent Brazil.
fra, fran will represent France
   .mail, .eml and .email Top Level Domains

These top level domains address the importance of having good domains available to users for email addresses. Since domain names are often used for email purposes, we feel there is a need for extensions in which their main focus will be email usage. The creation of new top level domains for email purposes will allow users to create user friendly and easy to remember email addresses. Domains created with these top level domains could also be used for websites.

An example email address using the mail extensions would be:
phill.wilson@336nc.mail

This email address would represent the person, Phill Wilson, who resides in the area code 336, which is located in North Carolina, which is a state in the United States of America. There are multiple ways email addresses can be created with the mail extension and my company will determine a uniform method of offering the mail top level domains.

Possible methods are:
Abbreviations: code1=state area code, code2=“state”
code1.mail, code2.mail, code1code2.mail
   .ml Top Level Domain

This top level is controlled by the country Mali. We would out of respect of the current domain name system get permission from them before we attempt to offer domain names including .ml st the top level domain. We are though introducing the idea of using .ml top level domain for email purposes.

.me Top Level Domain

This top level domain addresses the importance of having good domains available to users for personal website and communication purposes. While technology is developing in communicating over the internet there we predict that there will soon be a need for domains for different types of communication over the net such as chat, video, and phone. With domain usage people could communicate with audio, video and chat in a easy effective manner. An example of a possible domain created with the top level domain .me would be us.336.phill.wilson.me. This domain would represent the person Phill Wilson who resides in the United States of America, in the 336 area code. Another example is us.ny.mike.smith.me which represents Mike Smith, who resides in New York, a state in the United States. There a multiple ways one could create domains with the .me top level domain. We will offer the domains in a uniform manner.

Some possible forms of use of .me are:

Abbreviations:
1)code1=local area code
2)code2=state or prefecture abbreviation
3)(cc)=country code example: (us, jp . . . )
4)(cc2)=telephone country code example us=01 or 1

Possible Forms:
(a) code1.domain.domain.me
(b) (cc).code1.domain.domain.me
(c) (cc2).code1.domain.domain.me
(d) (cc).code2.domain.domain.me
(g) (cc2).code2.domain.domain.me

.dev Top Level Domain

Variable Definition
(+dev)=dev, dv, dvc,devi,devc,devic,device,comp,compt,computer, mac,mach,machn,machine,phn,phone,hh,appl

The (+.dev) top level domain will be to assign domain to internet capable devices such as hand held computers , desktop computer, home appliance or any type of device which can be communicated with or detected over the internet. e) The .dev top level domain will be used for internet capable devices. Domain names for this particular area will help individuals share information and communicate over internet capable devices. One of the proposed method of using the .dev top level domain is as follows:

Abbreviations and Variable Definitions
deviceid1=type of device appliance(app),notebook or desktop computer(comp), handheld(hh),phone(phn)
deviceid2=company, organization or person who owns device
deviceid3=anything combinations of letters or symbols that can be used in the domain name system
field2=area code of the device or device owner base location
field1=country area code in numeric or letter form (ex. United States=us or 01)

The following domains are in this format:
field1.field2.deviceid3.deviceid2.deviceid1.(+dev)

a. 01.336.phill.wilson.comp.dev

This domain would represent a desktop or laptop computer owned by Phill Wilson. The base location of either the computer or Phill Wilson or both is the area code 336, which is located in the United States of America.

b. 01.919.id912498.ibm.comp.dev

This domain would represent a desktop or laptop computer owned by the company IBM and the computers base location is area code 919, which is located in the United States of America.

c. 01.704.13452.ibm.hh.dev

This domain would represent a hand held device owned by the company IBM and the device's or companies or both base location is area code 704, which is located in the United States of America.

Some more proposed methods of using the .dev top level domains are:
1) field1.deviceid3.deviceid2.deviceid1.(+dev) (example: 01.13452.ibm.hh.dev)
2) field2.deviceid3.deviceid2.deviceid1.(+dev)
3) deviceid3.deviceid2.deviceid1. field1.field2.(+dev)
4) deviceid3.deviceid2.deviceid1. field2.field1.(+dev)
5) field1.field2.deviceid3.deviceid1.(+dev)

In our claims we claims the rights to use higher levels all the way to infinity of the top level domain .dev.

edu, .univ, .educ, .uni, .sch, .schl, .hs, .hsch, .hschl, .ms, .msch Top Level Domains

These top level domains have been created for the education communities. We feel that educational systems such as high schools, colleges and universities will benefit from more domain options. Because most if not all countries have educational system we feel that there is definitely a need for more than the one top level domain .edu which is used in the current domain. System. Examples of domains used in this system are:
1)duke.univ which may represent Duke University
2)northwood.nchs which may represent a high school in the State of North Carolina, located in the United States of America.
3)higherlearning.educ which may represent a learning institution called higher learning .edu would not be used by itself inorder not to conflict with the top level domain .edu assigned by ICANN
4) carmel.msch could represent Carmel Middle School.
   bz,b,c,cm,n,nt Used to Form Top Level Domains

bz, b, and c will be used in combination with other letters to make up top level domains bz and will represent biz, c and cm will represent cm and n and nt will represent net. Examples of top level domains created with these combination of letters are .usbz, and .jpb. .usbz would represent usbiz and jpb would represent jpbiz. The use of this format will allow people to input abbreviations for top level domains which contain com net and biz.

glb,gbl,glob,globl, global, int, intl New Top Level Domains

These top level domains are created for businesses and organizations that cater to the international and global community.

shop, sex, sx, tv Top Level Domains

We use shop because online shopping is big. We use sx and sex because online pornography is good. We use tv because we feel television is a major source of entertainment. We are inventing the use of these top level domains but we combine them with other letters to form top level domains such as: jpshop, sexus etc . . . We are inventing the combination of the top level domains: shop, sex, sx and tv with other letters.

Claims

Abbreviations, Symbols and Definitions for the Following Claims

1)code1=can be anything that represents an area within a state such as area code, city or zip code.

2)code2=any representation in a country similar to “states” in America such as California.
For example, for the country Japan, code2 would represent prefectures.
Code2 represent “states” in their abbreviated or regular form.

3)(cc)=standard country codes (example: us, jp) and country codes we introduce in this invention. (example: chn, jpa and usa, or glb,gbl,glob,globl, global, int, intl)

4)(cc2)=telephone country code, example: United States of America=01 or 1

5)(+tld)=com, biz, net, org, name, info, org, pro, web, bz, b, c, cm, n, nt, shop, sex, tv, sx, my, go, now

6)(n)=1,2,3 . . . (any integer number)

7) domain=is anything group of letters or characters which can be used in the current domain system (examples: product, store)

8) domain names are separated by commas (,)

9) The top level domain is what comes after that last . in each domain name example: domain.one, one is the top level domain

10) (+domain)=third, fourth, fifth . . . infinite level of the domain
Example 1: (+domain).biz=shop.now.biz
Example 2: (+domain).biz=the.best.store.biz

11) (+mail)=mail, email, eml or ml

We have used variables so we do not have to write out each instance. Variables which represent more than one combination of letters are used to represent different instances of top level domains.

Claims Note: In the claims in which multiple domains are mentioned within one domain name such as domain.domain.me the way the current domain name system is setup whoever controls the secondary level domain (domain.me) controls higher levels of the domain such as domain.domain.me. In our claims though we specify claims for secondary level domains and their higher levels because higher level domains do not have to be controlled by its secondary level controller. For instance the domain name shop.business.com. The way the internet is currently setup whoever controls business.com would be the assumed controller of shop.business.com. The controller of the top level domain .com would forward request for shop.business.com to the nameserver responsible for business.com which would in return point to the appropriate i.p for shop.business.com or forward the request to a nameserver which had that information. In this way the authoritative nameserver for business.com is the authoritative name server for shop.business.com. We are introduce the of the top level domain (.com) controller handling the request for shop.business.com the same way it

1. The creation and use of new top level domains, comprising
(a) any top level domain created to represent a particular area within a country of operation of a website or the span of area within a country in which the business or organization's operations cover.
(b) all combinations of top level domains assigned by ICANN with any top level domain created to represent the area of operation of a website or the span of area in which the business or organization's operations cover. These areas may be within a country or the country as a whole. The areas in this claim must be combined with tlds assigned by ICANN therefore top level country code based domains like .us and .jp are not included. An example of a domain created in this system is shop.usbiz. In this domain us represents the United States of America and biz is a top level domain approved by ICANN.
(c) all combinations of words, letters and symbols which represent the area of operation of a website or the span of area in which the business or organization's operations cover. These areas may be within a country or represent the country as a whole. An example of a domain created in this system is house.oneusa. Usa, which represents the United States of America, is used with one to create the top level domain oneusa.

2. The creation and use of new top level domains, comprising.
(a) domain.code1(cc), domain.code1(+tld), domain.code1code2, domain.(cc)code1, domain.(+tld)code1, domain.code2code1, domain.code1(cc2), domain.(cc2)code1
(b) domain.code2(cc),domain.code2(+tld),domain.(cc)code2,domain.(+tld)code2, domain.code2(cc2), domain.(cc2)code2
(c) domain.(cc)(+tld), domain.(+tld)(cc), domain.(cc2)(+tld), domain.(+tld)(cc2),domain.code1(cc)(n),domain.code1(+tld)(n), domain.code1code2(n),domain.(cc)code1(n),domain.(+tld)code1(n), domain.code2code1(n), domain.bizcode1(n), domain.code1(cc2)(n)
(d) domain.code2cc(n),domain.code2(+tld)(n), domain.(+tld)code2(n), domain.(cc2)code2(n), domain.(cc)code2(n),
(e) domain.(cc)(+tld)(n), domain.(+tld) (cc)(n), domain.(+tld)(cc2)(n)
(f) domain.(+tld)(n),domain.(n)(+tld),(+domain).code1(cc),(+domain).code1(+tld), (+domain).code1code2, (+domain).(cc)code1(+domain).(+tld)code1, (+domain).code2code1, (+domain).code1(cc2), (+domain).(cc2)code1
(g) (+domain).code2(cc), (+domain).code2(+tld), (+domain).(cc)code2, (+domain). (+tld)code2, (+domain).code2(cc2), (+domain).(cc2)code2
(h) (+domain).(cc)(+tld), (+domain).(+tld)(cc), (+domain).(cc2)(+tld), (+domain). (+tld)(cc2)
(i) (+domain).code1(cc)(n),(+domain).code1(+tld)(n),(+domain).code1code2(n), (+domain).(cc)code1(n),(+domain).(+tld)code1(n),(+domain).code2code1(n), (+domain).code1(cc2)(n)
(j) (+domain).code2cc(n), (+domain).code2(+tld) (n), (+domain).(cc)code2(n), (+domain).(+tld)code2(n), (+domain).(cc2)code2(n)
(k) (+domain).cc(+tld)(n), (+domain). (+tld)(cc)(n), (+domain).(+tld)(cc2)(n),
(l) (+domain).(+tld)(n), (+domain).(n)(+tld)
(m) domain.code1, domain.code2, domain.(cc2)

3. The creation and use of new top level domains for email purposes, comprising.
Claim note: We will use the top level domain .ml in the form domain.ml only if given the rights by the country Mali who has been given control over that domain by ICANN. We may though use a combination of ml with other words such as domain.mlbiz without the permission of Mali.
Symbols and Abbreviations for this claim
(+mail)=mail, email, eml or ml
(a) domain.mail,domain.email,domain.eml,domain.ml,domain.code1(+mail), domain.code2(+mail), domain.(cc)(+mail), domain.(+mail)code1, domain. (+mail)code2, domain.(+mail)(cc),domain.(+mail)(cc2), domain.(cc2) (+mail)
(b) domain.biz(+mail), domain.(+mail)biz, domain.com(+mail), domain.(+mail)com domain. (+mail)net, domain.net(+mail)
(c) domain.(+mail) (n)
(d) domain.code1(+mail), domain.code2(+mail), domain.(cc)(+mail), domain(cc2).(+mail)
(e) domain.code1code2(+mail),domain.code2(cc)(+mail), domain.code2(cc2)(+mail),domain.code2code1(+mail), domain.(cc)code2(+mail),domain.(cc2)code2(+mail), domain.code1(cc)(+mail),domain.code1(cc2)(+mail), domain.(cc)code1(+mail),domain.(cc2)code1(+mail)
(f) (+domain).(+mail),(+domain).code1(+mail), (+domain).code2(+mail), (+domain).(cc)(+mail), (+domain).(+mail)code1, (+domain).(+mail)code2, (+domain).(+mail)(cc), (+domain).(+mail)(cc2), (+domain).(cc2)(+mail)
(g) (+domain).biz(+mail), (+domain).(+mail)biz, (+domain).com(+mail), (+domain).(+mail)com, (+domain).(+mail)net, (+domain).net(+mail)
(h) (+domain).(+mail)(n)
(i) any top level domain created for email purposes

4. The creation and use of new top level domains, comprising
(a) domain.me
(b) domain.code1me, domain.mecode1, domain.code2me, domain.mecode2
(c) domain.(cc)me, domain.me(cc), domain.(cc2)me, domain.me(cc2)
(d) domain.(n)me, domain.me(n)
(e) domain.code1code2me,domain.code2code1me,domain.code1(cc)me, domain.(cc)code1me
(f) domain.mecode1code2,domain.mecode2code1,domain.mecode1(cc), domain.me(cc)code1
(g) domain.code2(cc)me, domain.(cc)code2me, domain.mecode2(cc), domain.mecode2(cc)
(h) (+domain).me
(i) (+domain).code1me, (+domain).mecode1, (+domain).code2me, (+domain).mecode2
(j) (+domain).(cc)me, (+domain).me(cc), (+domain).(cc2)me, (+domain).me(cc2)
(k) (+domain).(n)me, (+domain).me(n)
(l) (+domain).code1code2me, (+domain).code2code1me, (+domain).code1(cc)me, (+domain).(cc)code1me
(m) (+domain).mecode1code2, (+domain).mecode2code1, (+domain).mecode1(cc), (+domain).me(cc)code1
(n) (+domain).code2(cc)me,(+domain).(cc)code2me,(+domain).mecode2(cc), (+domain).mecode2(cc)
(o) domain.me(+mail), domain.(+mail)me, (+domain).me(+mail), (+domain).(+mail)me
(p) any top level domain created for personal website usage

5. The creation and use of new top level domains, comprising
Symbols for this claim:
(+dev)=dev, dv, dvc,devi,devc,devic,device,comp,computer, mac,mach,machn,machine,phn,phone,hh,appl
(a) domain.(+dev)
(b) domain.code1(+dev), domain.(+dev)code1, domain.code2(+dev), domain.(+dev)code2
(c) domain.(cc) (+dev), domain.(+dev)(cc), domain.(cc2)(+dev), domain.(+dev)(cc2)
(d) domain.(n)(+dev), domain.(+dev)(n)
(e) domain.code1code2(+dev),domain.code2code1(+dev),domain.code1(cc) (+dev), domain.(cc)code1(+dev)
(f) domain. (+dev)code1code2,domain.(+dev)code2code1,domain.(+dev)code1(cc), domain.(+dev)(cc)code1
(g) domain.code2(cc)(+dev), domain.(cc)code2(+dev),domain.(+dev)code2(cc), domain.(+dev)code2(cc)
(h) (+domain).(+dev)
(i) (+domain).code1(+dev),(+domain).(+dev)code1,(+domain).code2(+dev), (+domain).(+dev)code2
(j) (+domain).(cc)(+dev),(+domain).(+dev)(cc), (+domain).(cc2)(+dev), (+domain).(+dev)(cc2)
(k) (+domain).(n)(+dev), (+domain).(+dev)(n)
(l) (+domain).code1code2(+dev), (+domain).code2code1(+dev), (+domain).code1(cc)(+dev), (+domain).(cc)code1(+dev)
(m) (+domain).(+dev)code1code2, (+domain).(+dev)code2code1, (+domain).(+dev)code1(cc), (+domain).(+dev)(cc)code1
(n) (+domain).code2(cc) (+dev),(+domain).(cc)code2(+dev), (+domain).(+dev)code2(cc), (+domain).(+dev)code2(cc)
(o) domain. (+dev)(+mail), domain.(+mail) (+dev), (+domain).(+dev) (+mail), (+domain).(+mail)(+dev)
(p) any top level domain created for use by internet capable devices

6. Domain Name System including new top level domains comprising,
a) Any top level domain created for the purpose of communicating through the internet. Different types of internet communications include: online chatting, audio (telephone like) and or video. Types of communications can operate independently or together. An example of communications operating together is video chat by which the person can view the person while chatting with them.

7. The creation and use of new top level domains including new types of country code tlds, comprising
Symbols for this claim:
(+jpn)=ja, jp,jap,jpn, jpa, japa or japan
(+chn)=cn, ch, chi, chn, chin, chna, china
a) domain.(+jpn), (+domain).(+jpn) This does not include the top level domain jp which has been assigned by ICANN.
b) domain.(+chn), (+domain).(+chn). This does not include the domains .cn and .ch which have been assigned by ICANN.
c) domain.now, (+domain).now
d) domain.web, (+domain).web
e) domain.usa(n), domain.jpn(n), domain.chn(n) domain.now(n), domain.web(n), domain.dev(n)
f) (+domain).usa(n), (+domain).jpn(n), (+domain).chn(n)
g) (+domain).now(n), (+domain).web(n), (+domain).dev(n)

8. The creation and use of new top level domains including new types of country code tlds, comprising
Symbols and Abbreviations for this claim:
(+ncc)=ger, grm, gem, ind, indi, india, unk, untk, itl, ital, bra, brz, fra, fran or combination of letters used to represent any of the following countries with the exception of country codes already assigned by ICANN at the time of this invention creation: Germany, India, France, United Kingdom, Italy, or Brazil.
a) domain.(+ncc)

9. The creation and use of new top level domains for the European Community, comprising
The following variables represent areas within the European Community. These areas will be determined based on assignments made by whoever regulates the European Community or we will ourselves split the European Community into different areas. For this invention we assume the European Community is split into state and local areas similar to the way the United States use states and local area codes to represent areas within.
Symbols for this claim:
code1=local area code, code2=state or prefecture abbreviation
(cc)=.ec, eu, eur, euc, epc, euro
(cc2)=european community country telephone codes
(n)=any integer number
(a) domain.eur, domain.euc, domain.epc, domain.euro, (+domain).(eur), (+domain).euc, (+domain).epc, (+domain).euro
(b) domain.code1(cc),domain.code1com,domain.code1net, domain.code1code2, domain.code1biz,domain.(cc)code1,domain.comcode1, domain.netcode1,domain.code2code1,domain.bizcode1, domain.code1(cc2), domain.(cc2)code1
(c) domain.code2(cc), domain.code2com, domain.code2net, domain.code2biz domain.(cc)code2, domain.comcode2, domain.netcode2, domain.bizcode2domain.code2(cc2), domain.(cc2)code2
(d) domain.(cc)com, domain.(cc)net, domain.(cc)biz domain.com(cc), domain.net(cc), domain.biz(cc) domain.(cc2)com, domain.(cc2)net, domain.(cc2)biz domain.com(cc2), domain.net(cc2), domain.biz(cc2)
(e) domain.code1(cc)(n),domain.code1com(n),domain.code1net(n), domain.code1code2(n),domain.code1biz(n),domain.(cc)code1(n), domain.comcode1(n),domain.netcode1(n),domain.code2code1(n), domain.bizcode1(n), domain.code1(cc2)(n)
(f) domain.code2cc(n), domain.code2com(n), domain.code2net(n), domain.code2biz(n), domain.(cc)code2(n), domain.comcode2(n), domain.netcode2(n), domain.bizcode2(n), domain.(cc2)code2(n)
(g) domain.(cc)com(n), domain.(cc)net(n), domain.(cc)biz(n) domain.com(cc)(n), domain.net(cc)(n), domain.biz(cc)(n) domain.com(cc2)(n), domain.net(cc2)(n), domain.biz(cc2)(n)
(h) domain.(cc)(n), domain.(cc2)(n), domain.code1(n), domain.code2(n) domain.(n)(cc), domain.(n)(cc2), domain.(n)code1, domain.(n)code2
(i) (+domain).code1(cc),(+domain).code1com,(+domain).code1net, (+domain).code1code2,(+domain).code1biz,(+domain).(cc)code1, (+domain).comcode1,(+domain).netcode1, (+domain).code2code1, (+domain).bizcode1,(+domain).code1(cc2), (+domain).(cc2)code1
(j) (+domain).code2(cc), (+domain).code2com, (+domain).code2net, (+domain).code2biz, (+domain).(cc)code2(+domain).comcode2(+domain).netcode2, (+domain).bizcode2(+domain).code2(cc2), (+domain).(cc2)code2
(k) (+domain).(cc)com, (+domain).(cc)net, (+domain).(cc)biz (+domain).com(cc), (+domain).net(cc), (+domain).biz(cc) (+domain).(cc2)com, (+domain).(cc2)net, (+domain).(cc2)biz (+domain).com(cc2) (+domain).net(cc2) (+domain).biz(cc2)
(l) (+domain).code1(cc)(n),(+domain).code1com(n),(+domain).code1net(n), (+domain).code1code2(n)
(m) (+domain).code1biz(n),(+domain).(cc)code1(n),(+domain).comcode1(n), (+domain).netcode1(n),(+domain).code2code1,(n),(+domain).bizcode1(n), (+domain).code1(cc2)(n)
(n) (+domain).code2cc(n),(+domain).code2com(n),(+domain).code2net(n), (+domain).code2biz(n),(+domain).(cc)code2(n),(+domain).comcode2(n), (+domain).netcode2(n), (+domain).bizcode2(n), (+domain).(cc2)code2(n)
(o) (+domain).cccom(n), (+domain).ccnet(n), (+domain).ccbiz(n) (+domain).com(cc)(n), (+domain).net(cc)(n), (+domain).biz(cc)(n) (+domain).com(cc2)(n), (+domain).net(cc2)(n), (+domain).biz(cc2)(n) (+domain).(cc)(n),(+domain).(cc2)(n),(+domain).code1(n), (+domain).code2(n), (+domain).(n)(cc), (+domain).(n)(cc2), (+domain).(n)code1, (+domain).(n)code2
(p) domain.(cc)(+mail), domain.(cc2)(+mail), (+domain).code1(+mail), domain.code2(+mail)

10. The creation and use of new top level domains for the educational purposes, comprising
Symbols:
(+educ)=.univ, .edu, .educ, .uni, hs, .sch, .schl, .msch, .mschl, .hsch, .hschl
(a) domain.univ, domain.educ, domain.uni,domain,hs, domain.sch, domain.schl
(b) (+domain).univ, (+domain).educ, (+domain.uni),(+domain),hs, (+domain).sch, (+domain).schl
(c) domain.code1(+educ),domain.code2(+educ), domain.(cc)(+educ), domain.(cc2)(+educ), domain.(+educ)code1, domain.(+educ)code2, domain.(+educ)(cc), domain.(+educ)(cc2)
(d) domain.biz(+educ), domain(+educ)biz, domain.com(+educ), domain(+educ)com domain. (+educ)net, domain.net(+educ)
(e) domain.(+educ)(n)
(f) domain.code1(+educ), domain.code2(+educ), domain.(cc)(+educ), domain.(cc2)(+educ)
(g) domain.code1code2(+educ),domain.code2(cc)(+educ), domain.code2(cc2)(+educ),domain.code2code1(+educ),domain.(cc)code2(+educ), domain.(cc2)code2(+educ),domain.code1(cc)(+educ),domain.code1(cc2)(+educ), domain.(cc)code1(+educ), domain.(cc2)code1(+educ)
(h) (+domain).code1(+educ),(+domain).code2(+educ), (+domain).(cc)(+educ),(+domain).(+educ)code1,(+domain).(+educ)code2, (+domain).(+educ)(cc), (+domain).(+educ)(cc2), (+domain).(cc2) (+educ)
(i) (+domain).biz(+educ), (+domain).(+educ)biz, (+domain).com(+educ), (+domain).(+educ)com, (+domain).(+educ)net, (+domain).net(+educ)
(j) (+domain).(+educ)(n)
(k) domain.(+educ)mail, domain.mail(+educ)
(l) any top level domain which combines words representing a certain area such as area code, state or country with a word representing education such as .edu (education) or any type of educational system.

11. The creation and use of new top level domains for the government purposes, comprising
Symbols for this claim:
(+gov)=go,gov,govn,govm
(a) domain.go,domain.govn, domain.govm
(b) (+domain).go,(+domain).govn, (+domain).govm
(c) domain.code1(+gov),domain.code2(+gov), domain.(cc)(+gov), domain.(+gov)code1, domain.(+gov)code2, domain.(+gov)(cc), domain.(+gov)(cc2), domain.(+gov)(+mail)
(d) domain.biz(+gov), domain(+gov)biz, domain.com(+gov), domain(+gov)com, domain. (+gov)net, domain.net(+gov)
(e) domain.(+gov)(n)
(f) domain.code1(+gov), domain.code2(+gov), domain.(cc)(+gov), domain.(cc2)(+gov)
(g) domain.code1code2(+gov),domain.code2(cc)(+gov), domain.code2(cc2)(+gov),domain.code2code1(+gov),domain.(cc)code2(+gov), domain.(cc2)code2(+gov),domain.code1(cc)(+gov),domain.code1(cc2)(+gov), domain.(cc)code1(+gov), domain.(cc2)code1(+gov)
(h) (+domain).(+gov),(+domain).code1(+gov),(+domain).code2(+gov), (+domain).(cc)(+gov),(+domain).(+gov)code1,(+domain).(+gov)code2, (+domain).(+gov)(cc), (+domain).(+gov)(cc2), (+domain).(cc2) (+gov)
(i) (+domain).biz(+gov), (+domain).(+gov)biz, (+domain).com(+gov), (+domain).(+gov)com, (+domain).(+gov)net, (+domain).net(+gov)
(j) (+domain).(+gov)(n)
(k) domain.(+gov)mail, domain.mail(+gov)
(l) any top level domain which combines words representing a certain area (area code, state or country) with a word representing government such as gov or any type of government system. Examples of combinations are .jpgov which would represent the government of Japan and .usgov which would represent the United States of America government.
Note: claims 12 and 13 are for the “Reverse Domain System”

12. A Domain Name System which includes new types of domains, comprising
(a) domain names which include top level domain assigned by ICANN and the ones we introduce in this invention on the secondary level. The top level of the domains include any combination of letters or symbols which can be used in the domain name system. The top level of the domains do not include top level domains currently assigned by ICANN. In the domain com.business, com is on the secondary level and business is on the top level.

13. A Domain Name System including new types of domains, comprising
Symbols for this claim:
(+hld)=my, go, shop
(a) biz.domain, com.domain, net.domain
(b) biz(n).domain, com(n).domain, net(n).domain
(c) code1.domain, code2.domain, (cc).domain, (cc2).domain
(d) code1biz.domain,code1com.domain,code1net.domain
(e) code(n).domain, code2(n).domain, (cc)(n).domain, (cc2)(n).domain
(f) code1biz(n).domain,code1com(n).domain,code1net(n).domain
(g) code2biz(n).domain,code2com(n).domain,code2net(n).domain
(h) domain.w, domain.ww, domain.www
(i) (+hld).domain, domain.my, domain.go, domain.now
(j) (+hld)(n).domain
(k) code1(+hld).domain, (+hld)code1.domain
(l) code2(+hld).domain, (+hld)code2.domain
Note: claim 14 is a claim for the “higher level domain system”

14. Domain Name System including new types of domains, comprising
(a) A Domain Name System in which multiple users can use the same base domain with a different third or higher level domain. Multiple base domains can be used by multiple users. We do not include the third level of the top level domain, .name.
(b) Create authoritative nameservers for higher level domains (third level, fourth, and higher) which the root name servers use in forwarding request for higher level domains to the appropriate name servers.

15. A domain name system including the following higher level domains, comprising
(a) domain.code2.(cc)
(b) domain.(cc).(+tld)
(c) domain.code2.(cc).(+tld)
(d) domain.code1.code2.(cc)
(e) domain.code1.code2.(cc).(+tld)

16. Search Engines which perform website searches based on:
(a) user's location. User's location means where the person, who is searching the internet for information, resides or is located when performing the search.
(b)search area requested by user. Search area refers to the area of interest of the searcher. Area information may contain all or some of the following information: country, “state” or local area information.

17. Search Engines retrieving information about a domain or website by the following methods:
(a) Search Engine reads the top level of the domain (Example the domain topcars.nc336 may represent a website located in North Carolina, which is a state in the United States)
(b) Search Engines retrieves information on a domain from a whois or whois like database. Whois databases contain information about the location of the person, business or organization that registered the domain, and the location of the Administrative Contact, Technical Contact and Billing Contact for the domain.
(c) When someone registers with search engines they could input the location of the website they are registering. Location can mean wither the span of area in which the business covers or where the business's base operation is located. Search Engines then references this information when performing searches on websites.
(d) Search Engines read the higher level of the domain (third level or higher). For example in the domain name one.two.three.com, one and two are higher level parts of the domain. Two is on the third level and one is on the fourth level.
(e) Search Engines read the secondary level of a domain looking for information regarding location of a website. Location can mean either the span of area in which the business covers or where the business's base operation is located. Secondary level of a domain name is the part before the top level. For example in the domain name business.com, business is the secondary level of the domain name.

18. A Domain Name System including new types of domains, comprising
(a) Domain Names which include symbols other than periods (.) to separate its different levels. Symbols include but are not limited to the following symbols: ! @ # $ % \hat{ } & * ( ) _ + | − = \ { } [ ] : ″ ; ′ < > ?, /
(b) Domains which include periods and other symbols to separate its different levels.

19. The creation and use of new top level domains for wireless and mobile purposes, comprising
Symbols:
(+mobile)=mbl, mob, mobi, mobile, wirel, wirl
(a) domain.(+mobile), (+domain).(+mobile)
(b) domain.code1(+mobile), domain.(+mobile)code1, domain.code2(+mobile), domain. (+mobile)code2
(c) domain.(cc)(+mobile), domain.(+mobile)(cc), domain.(cc2)(+mobile), domain.(+mobile)(cc2)
(d) domain.(n)(+mobile), domain.(+mobile)(n)
(e) domain.code1code2(+mobile),domain.code2code1(+mobile),domain.code1(cc) (+mobile), domain.(cc)code1(+mobile)
(f) domain.(+mobile)code1code2,domain.(+mobile)code2code1, domain.(+mobile)code1(cc), domain.(+mobile)(cc)code1
(g) domain.code2(cc)(+mobile), domain.(cc)code2(+mobile), domain.(+mobile)code2(cc), domain.(+mobile)code2(cc)
(h) (+domain).code1(+mobile),(+domain).(+mobile)code1, (+domain).code2(+mobile), (+domain).(+mobile)code2
(i) (+domain).(cc)(+mobile),(+domain).(+mobile) (cc), (+domain).(cc2)(+mobile), (+domain).(+mobile)(cc2)
(j) (+domain).(n)(+mobile), (+domain).(+mobile)(n)
(k) (+domain).code1code2(+mobile), (+domain).code2code1(+mobile), (+domain).code1(cc)(+mobile), (+domain).(cc)code1(+mobile)
(l) (+domain).(+mobile)code1code2, (+domain).(+mobile)code2code1, (+domain). (+mobile)code1(cc), (+domain).(+mobile)(cc)code1
(m) (+domain).code2(cc) (+mobile),(+domain).(cc)code2(+mobile), (+domain).(+mobile)code2(cc), (+domain).(+mobile)code2(cc)
(n) domain.(+mobile)(+mail), domain.(+mail)(+mobile), (+domain).(+mobile) (+mail), (+domain).(+mail)(+mobile)
(o) any top level domain created by using the word wireless or mobile or any abbreviations for wireless or mobile

20. The creation and use the new top level domains and domain systems, invented in this patent, in other languages, comprising
(a) The conversion and use of the top level domains in the following languages: English, Chinese, Japanese, French, Spanish, and German (Deutsche)
(b) The conversion and use of the top level domains into any other languages not included in claim a.
